(19) United States
(12) Patent Application Publication
(10) Pub. No.: US 2011/0167857 A1
(43) Pub. Date: Jul. 14, 2011

(54) MEDICAL IMAGE RECORDING DEVICE FOR MAGNETIC RESONANCE AND PET IMAGING

(75) Inventors: James L. Corbeil, Knoxville, TN (US); Stefan Stocker, Grossenseebach (DE)

(73) Assignee: SIEMENS AKTIENGESELLSCHAFT, Munich (DE)

(21) Appl. No.: 12/986,326

(22) Filed: Jan. 7, 2011

(30) Foreign Application Priority Data
Jan. 11, 2010 (DE) 10 2010 004 302.8

(51) Int. Cl. F25D 31/00; G01V 3/00

(52) U.S. Cl. 62/259.2; 324/318

(57) ABSTRACT

A medical image recording device includes a device for magnetic resonance imaging including a cylindrical gradient coil with coil conductors arranged on multiple radial levels; and a device for PET imaging including multiple PET detectors arranged in a cylindrical arrangement in the interior of the gradient coil. In at least one embodiment, at least one cooling device is provided between the coil conductor lying on the innermost radial level and the PET detectors arranged in annular form on at least one radial level.

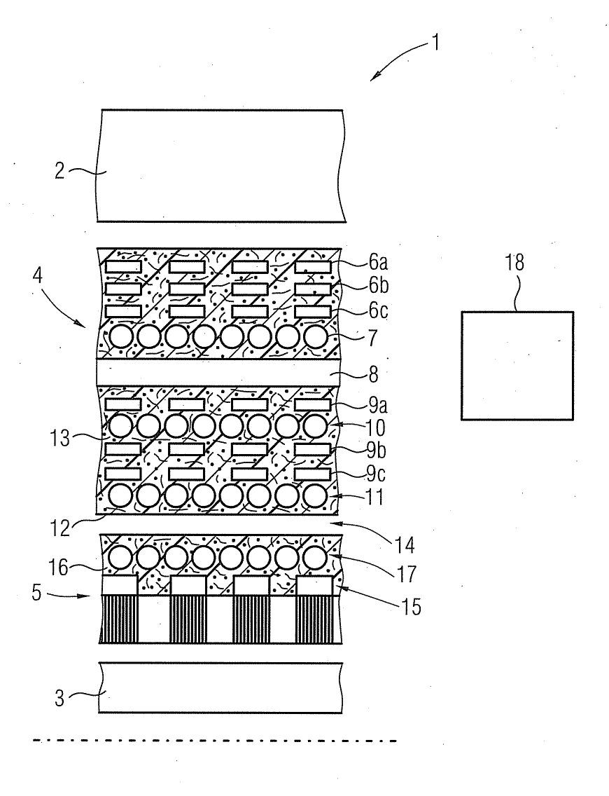

### PRIORITY STATEMENT

The present application hereby claims priority under 35 U.S.C. §119 on German patent application number DE 10 2010 004 302.8 filed Jan. 11, 2010, the entire contents of which is hereby incorporated herein by reference.

### FIELD

Embodiments of the invention generally relate to a medical image recording device with a device for magnetic resonance imaging comprising a cylindrical gradient coil with coil conductors arranged in several radial levels and/or a device for PET imaging comprising multiple PET detectors arranged in a cylindrical arrangement in the interior of the gradient coil.

### BACKGROUND

Modern imaging devices increasingly have two different imaging modalities. One example of such an imaging device is a combined MR-PET system, that is a device that has an imaging unit for magnetic resonance imaging and an imaging unit for PET imaging (PET=Positron Emission Tomography). The magnetic resonance imaging serves to display structures and functions of the tissue or the organs of the body, and is based on the physical principles of nuclear magnetic resonance. With a magnetic resonance system various image recording methods can be performed, for example the customary magnetic resonance tomography which generates sectional images, magnetic resonance angiography, functional magnetic resonance tomography, perfusion and diffusion magnetic resonance tomography and magnetic resonance lastography.

Positron Emission Tomography is likewise an imaging method, though it is assigned to the field of nuclear medicine. Sectional images of living organisms can be created by these means too, in that the distribution of a weakly radioactively marked substance in the organism can be rendered visible in the recorded image, by which biochemical and physiological functions can be mapped. Thus, what is involved here is an embodiment of functional imaging.

The PET imaging unit comprises detectors arranged in annular form, where the principle of examination includes the recording of coincidences between in each case two detectors lying immediately opposite each other, whereby, using the temporal and spatial distributions of these registered decay events of the radionuclide, conclusions are drawn about the spatial distribution of the same within the interior of the body. Sectional images can be computed from this.

In order to record the decay events on the detector side, the PET detectors have silicon-based receiver sensors such as for example APDs (APD=Avalanche Photo Diode) or silicon photomultipliers. These have temperature-dependent properties such as their transfer function and their noise behavior, which properties generally deteriorate with increasing temperature.

As the PET detector ring is arranged in the interior of the cylindrical gradient coil and, in order to create sufficient space for the patient, is sited as close as possible to the gradient coil, at a distance of just a few millimeters, problems inevitably arise, as the gradient coil becomes warm during operation of the magnetic resonance device. The surface temperature of the gradient coil on its inner skin surface varies during operation between 20-100° C. That is to say that there is an inevitable thermal influence on the temperature-sensitive PET detectors in relation to their receiver sensors, where the PET imaging sometimes also proceeds simultaneously with the MR imaging.

### SUMMARY

In at least one embodiment, the invention specifies an image recording device in which the closest possible arrangement of the PET detectors relative to the gradient coil is possible without disadvantageous thermal influence on the PET detectors arising.

According to at least one embodiment of the invention, a cooling device is provided on at least one radial level between the coil conductor on the innermost radial level and the PET detectors which are arranged in annular form.

In at least one embodiment of the inventive image recording device, at least one cooling device, which like the gradient coil or the detector ring is likewise embodied in cylindrical form, is provided between the coil conductor which lies furthest in, viewed radially, and the PET detectors. This means that at least one cooling layer is introduced between the heat-generating gradient coil conductor and the PET detectors, which are sensitive to temperature changes, which greatly reduces the heat transfer from the gradient coil to the PET detectors in relation to their bearing structure. By these means it is ensured that despite powerful heating of the gradient coil conductors, the PET detectors are almost at room temperature. The result of this is that no deterioration of the transfer function and the noise behavior of the detectors arises, which ultimately results in an improvement in the imaging quality of the PET system.

The cooling device itself, which for example comprises one or more coolant pipes arranged lying adjacent to each other, so that an arrangement arises which is a flat as possible and structured in the least radial manner possible, can either be provided on the gradient coil or on the PET detector arrangement. That is to say, it may be integrated either on the coil side or on the detector side. Alternatively, there is also the possibility of positioning the cooling device as a separate component between the gradient coil and the PET detector arrangement.

Particularly preferable is an arrangement of the cooling device on the gradient coil and there in particular an embedding of the cooling device in a casting compound embedding the coil conductor of the gradient coil. A gradient coil that serves spatial encoding purposes comprises both primary coils lying radially further in, which are assigned to the three spatial axes, and secondary coils lying radially further out, which are likewise assigned to the three spatial axes. In between are generally cooling layers, which enable cooling of the gradient coil in its interior. The entire assembly is molded into a casting compound, generally an epoxy resin, so that all gradient components are completely embedded in the casting compound.

According to at least one embodiment of the invention, the additional cooling device, which serves to provide thermal shielding of the PET detectors, is now likewise embedded in this casting compound on the internal side of the gradient coil, and is thus integrated into the coil casting compound. This enables an optimum thermal linkage of the cooling device to the heat source, specifically in particular the immediately adjacent coil radial level. It can hereby be achieved that the gradient coil surface remains relatively cold when in operation, and heats up, if at all, to only slightly above room temperature. Excessive heat transport to the PET detector level is advantageously prevented.

As an alternative to being embedded in the gradient coil, it is also possible to arrange the cooling device in a casting compound embedding the PET detectors or on a holder fixing the PET detectors. In this inventive embodiment, the cooling thus takes place directly on the PET detector ring itself.

In principle the possibility also exists of in each case providing a separate cooling device both on the coil side and on the detector side, that is to say that a first and a second cooling device is provided, wherein the first cooling device is provided on the gradient coil and the second cooling device on the PET detector arrangement. Optimum detector cooling is thereby achieved. The integration of a second cooling device on the PET detector ring is an associated advantage, as heat occurring on the detector side can thereby be dissipated, as can any residual heat affecting the gradient coil.

In particular if a cooling device comprises coolant pipes with the flattest possible cross section arranged adjacent to each other, a cooling device can basically be embodied in very flat form, that is structured only in a slightly radial manner, with the result that even in the case of the integration of a first and a second cooling device, the entire radial structure is not excessively large, and a sufficiently large internal diameter of the patient bore at the same time as the closest possible arrangement of the detector ring on the gradient coil continues to be possible. The flattest possible arrangement is also advantageous to that end, as uncooled areas can be avoided.

Even if in principle the possibility exists to supply the one or several cooling devices serving detector protection purposes with coolant, for example water via a separate coolant supply, an expedient development of the invention provides for this coolant device(s) also to be linked with a coolant supply, via which a further cooling device, provided in the interior of the gradient coil, is supplied. This means that ultimately the one or more additionally integrated cooling devices are connected in parallel to the cooling devices which are anyway provided on the coil side, as a result of which the flow resistance of the coolant in the gradient coil falls. In addition, only one coolant supply (comprising a cooler along with a coolant pump) is provided, which simplifies the overall structure of the image recording device.

### BRIEF DESCRIPTION OF THE DRAWINGS

Further advantages, features and details of the invention emerge from the exemplary embodiment described below, as well as from the drawing figure. The figure shows an embodiment of an image recording device 1.

### DETAILED DESCRIPTION OF THE EXAMPLE EMBODIMENTS

Various example embodiments will now be described more fully with reference to the accompanying drawing in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawing and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figure. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The Figure shows a representation of the principle of an inventive image recording device 1 of an embodiment, in the form of an extract, where only the important parts of relevance to an embodiment of the invention are represented.

The Figure shows a representation of the principle of an inventive image recording device 1 of an embodiment, in the form of an extract, where only the important parts of relevance to an embodiment of the invention are represented. As well as a main field magnet 2 and an HF full body transmit and receive coil 3, a gradient coil 4 and a PET detector arrangement 5 are also shown.

The gradient coil 4 comprises radially external secondary coils 6a, 6b and 6c, which are arranged at different radial levels. Viewed radially inwards a cooling device 7 comes next, followed in turn by a shim layer 8. Connected to this are primary coils 9a, 9b and 9c, lying at three radial levels, where a further cooling device 10 is integrated between the primary coils 9a and 9b. The cooling devices 7 and 10 are formed by coolant pipes disposed according to a predefined pattern, where the pattern of disposition is generally selected dependent upon the course of the individual primary and secondary coils.

A further first cooling device 11 is provided for, which viewed radially inwards, follows the primary coil 9c. It lies immediately adjacent to the internal surface 12 of the cylindrical gradient coil 4, that is to say the inner coil surface 12 is thereby cooled over a wide area. All gradient coil components are molded in a casting compound 13, for example an epoxy resin, thus also along with the further first cooling device 11, which serves to provide surface cooling.

Likewise arranged in the interior of the gradient coil 4 is the cylindrical PET detector arrangement 5, which is generally spaced at a distance from the surface of the gradient coil by means of narrow air gap 14 a few millimeters in width. This narrow gap is required in order to be able to remove the PET detector arrangement 5 from the gradient coil in the event of servicing being required, to which end the PET detector arrangement 5 has rollers (not shown in greater detail) which run on the surface 12 of the gradient coil.

The PET detector arrangement 5 has a multiplicity of PET detectors 15 arranged axially (that is in the direction of the longitudinal axis of the cylinder), which are arranged in a suitable detector holder and in the example shown are molded radially externally by way of a casting compound 16. Arranged herein is a cylindrically arranged second cooling device 17, which, like the cooling device 11, comprises coolant pipes, which are arranged adjacent to each other and are positioned as flat as possible, so that wide-scale cooling takes place over the entire axial length, corresponding to the design of the cylindrically formed cooling device 11. The heat arising on the detector side can be dissipated via this second cooling device 17, as can any heat transferred from the gradient coil 4, insofar as the surface 12 of the gradient coil heats up during operation, that is when current is passed through the gradient coils 6a-6c and 9a-9c. Excessive heating is anyway already prevented by the heat being dissipated by means of the large-area first cooling device 11, with the remaining residual heat, which is transferred to the PET detector arrangement 5 and, were it not dissipated, would however lead to slight heating of the PET detectors 15, being dissipated via the second large-area cooling device 17. Consequently no notable heating of the PET detectors 15 ensues, that would in any way influence the operational properties of the PET detectors 15.

Also shown is a central coolant supply 18, via which all cooling devices 7 and 10 as well as the additional cooling devices 11 and 17, which ultimately serve to form a cooling shield to protect the PET detectors 15, are supplied with coolant, for example water. This means that the coolant circuits in which the cooling devices 7, 10, 11 and 17 are integrated, are ultimately all connected in parallel, and are fed by a shared coolant supply 18.

Even if a further first and a further second cooling device 11, 17 is provided in the described example embodiment, it is basically sufficient to provide just one, preferably the first cooling device 11, which is embedded in the casting compound 13 integrated respectively on the gradient coil side. It is already sufficient to ensure sufficient heat dissipation, which prevents the gradient coil surface 12 heating up to any notable extent. While without the integration of the first cooling device 11, the gradient coil surface 12 can heat up to as much as 100° C. during operation, the integrated first cooling device 11 alone makes it possible to limit the heating of the surface to a maximum of around 35° C. No significant thermal influence on the PET detectors 15 is to be observed.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

1 Image recording device
2 Main field magnet
3 Receiver coil
4 Gradient coil
5 PET detector arrangement
6a Secondary coil
6b Secondary coil
6c Secondary coil
7 Cooling device
8 Shim layer
9a Primary coil
9b Primary coil
9c Primary coil
10 Cooling device
11 Cooling device
12 Interior surface
13 Casting compound
14 Air gap
15 PET detector
16 Casting compound
17 Cooling device
18 Coolant supply

What is claimed is:

1. A medical image recording device, comprising:
a device for magnetic resonance imaging comprising a cylindrical gradient coil including coil conductors arranged on a multiplicity of radial levels, a cooling device being provided between a coil conductor, of the coil conductors, lying at an innermost radial level; and
a device for PET imaging comprising a multiplicity of PET detectors arranged in a cylindrical arrangement in an interior of the gradient coil, the PET detectors being arranged in annular form on at least one radial level.

2. The medical image recording device as claimed in claim 1, wherein the cooling device is arranged on the gradient coil or on the PET detector arrangement, or is arranged as a separate component between the gradient coil or PET detector arrangement.

3. The medical image recording device as claimed in claim 1, wherein the cooling device is embedded in a casting compound embedding the coil conductor of the gradient coil.

4. The medical image recording device as claimed in claim 1, wherein the cooling device is arranged in a casting compound embedding the PET detectors or on a holder fixing the PET detectors.

5. The medical image recording device as claimed in claim 1, wherein the cooling device includes a first and a second cooling device, where the first cooling device is arranged on the gradient coil and the second cooling device on the PET detector arrangement.

6. The medical image recording device as claimed in claim 1, wherein the cooling device comprises coolant pipes arranged lying adjacent to each other.

7. The medical image recording device as claimed in claim 1, wherein the cooling device is coupled with a coolant supply, via which the supplying of further cooling devices provided in the interior of the gradient coil takes place.

8. The medical image recording device as claimed in claim 2, wherein the cooling device is embedded in a casting compound embedding the coil conductor of the gradient coil.

9. The medical image recording device as claimed in claim 2, wherein the cooling device is arranged in a casting compound embedding the PET detectors or on a holder fixing the PET detectors.

10. The medical image recording device as claimed in claim 2, wherein the cooling device includes a first and a second cooling device, where the first cooling device is arranged on the gradient coil and the second cooling device on the PET detector arrangement.

11. The medical image recording device as claimed in claim 2, wherein the cooling device comprises coolant pipes arranged lying adjacent to each other.

12. The medical image recording device as claimed in claim 5, wherein the cooling devices are coupled with a coolant supply, via which the supplying of further cooling devices provided in the interior of the gradient coil takes place.

12. The medical image recording device as claimed in claim 5, wherein the cooling devices comprises coolant pipes arranged lying adjacent to each other.
